(19) United States
(12) Patent Application Publication
(10) Pub. No.: US 2025/0281994 A1
(43) Pub. Date: Sep. 11, 2025

(54) WELDING APPARATUS AND WELDING MONITORING DEVICE

(71) Applicants: KABUSHIKI KAISHA TOSHIBA, Tokyo (JP); TOSHIBA DIGITAL SOLUTIONS CORPORATION, Kanagawa (JP)

(72) Inventors: Akira Kojima, Kawasaki Kanagawa (JP); Yasufumi Tahara, Yokohama Kanagawa (JP)

(21) Appl. No.: 18/829,085

(22) Filed: Sep. 9, 2024

(30) Foreign Application Priority Data
Mar. 8, 2024 (JP) 2024-035815

(51) Int. Cl. B23K 9/12; B25J 9/00; B25J 11/00

(52) U.S. Cl. CPC B23K 9/126; B25J 9/0087; B25J 11/005

(57) ABSTRACT

According to one embodiment, a welding apparatus includes a first welding machine including a first torch member formed of a metallic material to weld a first weld zone of a weld object, a second welding machine including a second torch member formed of a metallic material to weld a second weld zone of the weld object, a first sensor installed on the first torch member to detect an elastic wave transmitted to the first torch member, a second sensor installed on the second torch member to detect an elastic wave transmitted to the second torch member, and first and second processing circuits determining a welding condition of the first weld zone and the second weld zone based on a detection signal from the first sensor and the second sensor.

### CROSS-REFERENCE TO RELATED APPLICATIONS

This application is based upon and claims the benefit of priority from Japanese Patent Application No. 2024-035815, filed Mar. 8, 2024, the entire contents of which are incorporated herein by reference.

### FIELD

Embodiments described herein relate generally to a welding apparatus and a welding monitoring device.

### BACKGROUND

If melting, solidification, plastic deformation, fracture, or phase transformation occurs in a structure during welding, rapid release of energy may results in a phenomenon that unsteady elastic waves, so-called acoustic emissions (hereinafter simply referred to as “AE”) occurs in a weld object. There is a known technique for detecting elastic waves generated by the phenomenon, so-called AE waves, by an AE sensor, analyzing the waveform, and thereby determining the welding condition and weld quality of the weld object.

Monitoring the welding condition is performed by detecting the AE waves generated during arc welding by the AE sensor and converting the waves into electrical signals. In this case, the AE sensor is installed on the side of the weld object. When a plurality of parts are welded simultaneously on a single weld object, the AE waves generated at a plurality of weld zones are mixed, superimposed, and input to the AE sensor. For this reason, it is difficult to accurately monitor the welding conditions of individual weld zones by detection, recording, and determination based on the detection signals of the AE sensor installed on the weld object side.

### BRIEF DESCRIPTION OF THE DRAWINGS

FIG. 1 is a plan view schematically showing a welding apparatus according to an embodiment.

FIG. 2 is a diagram showing a torch member and a monitoring device of the welding apparatus.

FIG. 3 is a perspective view showing a proximal end portion of the torch member and the AE sensor.

FIG. 4 is a flowchart showing a monitoring operation of a weld zone in the welding apparatus.

FIG. 5A is a diagram showing the welding timing of the welding apparatus.

FIG. 5B is a diagram showing a detection signal intensity of a first AE sensor.

FIG. 5C is a diagram showing a detection signal intensity of a second AE sensor.

### DETAILED DESCRIPTION

Various embodiments will be described hereinafter with reference to the accompanying drawings. In general, according to one embodiment, a welding apparatus comprises: a first welding machine comprising an arm, a first torch member including a proximal end portion connected to the arm, a distal end portion opposed to a weld object, and a flat installation surface and formed of a metallic material, a welding electrode inserted into the first torch member and protruding from the distal end portion, and a power supply unit which applies a voltage between the welding electrode and the weld object, to weld a first weld zone of the weld object; a second welding machine comprising an arm, a second torch member including a proximal end portion connected to the arm, a distal end portion opposed to the weld object, and a flat installation surface and formed of a metallic material, a welding electrode inserted into the second torch member and protruding from the distal end portion, and a power supply unit which applies a voltage between the welding electrode and the weld object, to weld a second weld zone different from the first weld zone of the weld object; and a monitoring device comprising a first sensor installed on the installation surface of the first torch member and configured to detect an elastic wave transmitted to the first torch member, a second sensor installed on the installation surface of the second torch member and configured to detect an elastic wave transmitted to the second torch member, a first processing circuit configured to determine a welding condition of the first weld zone based on a detection signal transmitted from the first sensor, and a second processing circuit configured to determine a welding condition of the second weld zone based on a detection signal transmitted from the second sensor.

The disclosure is merely an example, and proper changes within the spirit of the invention, which are easily conceivable by a person of ordinary skill in the art, are included in the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted or simplified unless necessary.

### EMBODIMENTS

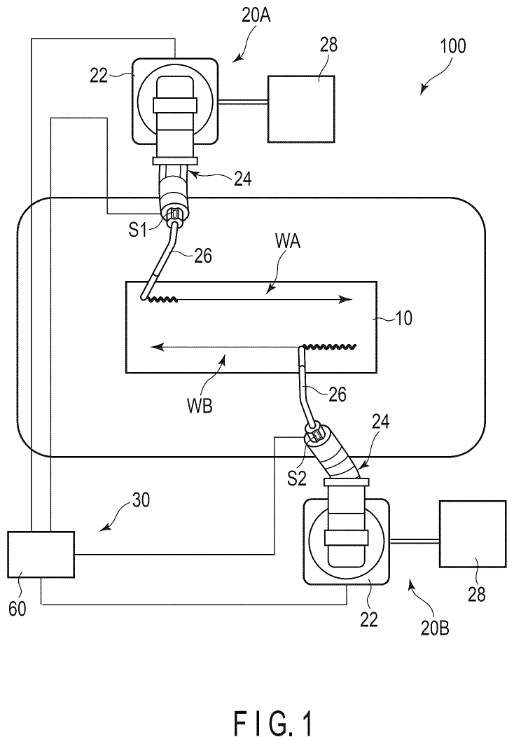

FIG. 1 is a plan view schematically showing a welding apparatus according to an embodiment.

As shown in the drawing, a welding apparatus 100 comprises a plurality of welding machines that weld any parts of a welded object 10, a monitoring device 30 that monitors the welding state of each welding machine, and a controller 60 that controls the operations of the plurality of welding machines and the monitoring device.

In the present embodiment, the welding apparatus 100 comprises a first welding machine 20A that welds a first weld zone WA of the welded object 10, such as a structure, and a second welding machine 20B that welds a second weld zone WB of the welded object 10 different from the first weld zone WA. The first weld zone WA and the second weld zone WB correspond to parts of the same welded object 10, each extending in a straight or curved shape and located to be separated from each other. In one example, the welded object 10 is a metal sheet material formed of steel, stainless steel, or the like, but is not limited thereto.

The first welding machine 20A includes a base 22, a robot arm 24 provided on the base 22 to be freely rotatable, a torch member 26 (sometimes referred to as a first torch member) attached to a distal end portion of the robot arm 24, and a power supply unit 28 that applies a drive voltage between a welding electrode to be described later and the welded object 10.

The base 22 may be either a fixed base or a self-propelled base. The robot arm 24 is an arm that can be freely positioned over a space and is, for example, a robot arm that can rotate and move about four or six axes. The torch member 26 is formed of a metal material capable of propagating processing waves generated during the processing of the welded object 10, for example, the elastic waves (acoustic emission: AE waves) generated by the welded object 10 during the welding operation. A welding electrode (metal wire) is inserted into the torch member 26 and protrudes from the distal end portion of the torch member 26.

The second welding machine 20B is constructed in the same manner as the first welding machine 20A. In other words, the second welding machine 20B includes a base 22, a robot arm 24 provided on the base 22 to be freely rotatable, a torch member 26 (sometimes referred to as a second torch member) attached to the distal end portion of the robot arm 24, and a power supply unit 28 that applies a drive voltage between a welding electrode to be described later and the welded object 10.

The first welding machine 20A and the second welding machine 20B are arranged on both sides of the welded object 10 with the welded object 10 arranged in between.

The monitoring device 30 includes a first AE sensor S1 attached to the torch member 26 of the first welding machine 20A, a second AE sensor S2 attached to the torch member 26 of the second welding machine 20B, a first processing circuit that processes the detection signal of the first AE sensor S1, and a second processing circuit that processes the detection signal of the second AE sensor S2.

The first AE sensor S1 is installed at the proximal end portion of the torch member 26 of the first welding machine 20A and detects the AE waves propagating through the torch member 26. The second AE sensor S2 is installed at the proximal end portion of the torch member 26 of the second welding machine 20B and detects the AE waves propagating through the torch member 26 of the second welding machine 20B. In the present embodiment, the first and second processing circuits are configured within the controller 60.

The configuration of the torch member and the configuration of the controller will be described in detail below.

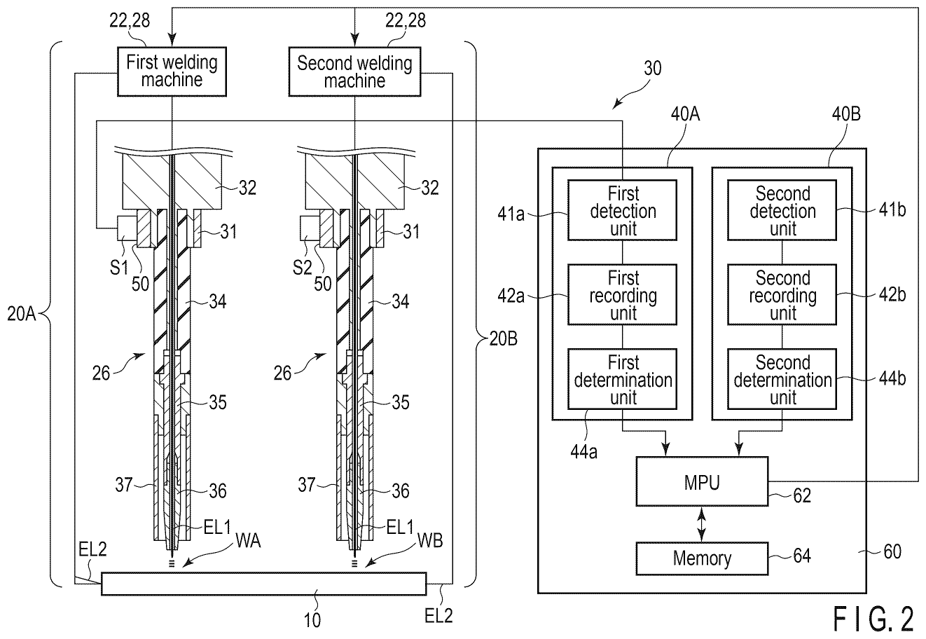

FIG. 2 is a diagram showing the cross-sectional structure of the torch member and the configuration of the controller.

As shown in the drawing, the torch member 26 of the first welding machine 20A is formed of a metal material capable of propagating the AE waves and is shaped in an elongated rod, and has a proximal end portion (joint block 31) connected to the robot arm 24 and a distal end portion adjacent and opposed to the welded object 10. In one example, the torch member 26 includes a torch body clamp 32 connected to the robot arm 24 or constituting a part of the robot arm 24, a sleeve-shaped torch body 34 having one end connected to the torch body clamp 32, a tubular tip body 35 having one end connected to the other end of the torch body 34, an elongated tip 36 having one end connected to the other end of the tip body 35 and including an inner hole, a tubular nozzle 37 having one end connected to the other end of the tip body 35, and a joint block 31 connected to one end of the torch body 34 and the robot arm 24.

In the present embodiment, the joint block 31 is attached to the torch body clamp 32, but may be attached to the torch body 34.

The torch body clamp 32, the torch body 34, the tip body 35, the tip 36, the nozzle 37, and the joint block 31, which constitute the torch member 26, are formed of metal materials capable of propagating the AE waves, such as steel, copper, and brass, but the metal materials are not limited to these. Furthermore, the torch body clamp 32, the torch body 34, the tip body 35, the tip 36, the nozzle 37, and the joint block 31 are tightly attached to each other and constitute a continuous structure. The torch body 34 in the present embodiment has a straight shape, but may have a curved shape.

The first welding machine 20A includes a welding electrode EL1 as a first electrode and a second electrode EL2 that pairs with the welding electrode EL1 and energizes the welded object 10. The welding electrode EL1 is a long, thin metal wire, which is inserted from the robot arm 24 into a passage (inner hole) of the torch member 26 and extends to the distal end portion of the torch member 26. The welding electrode EL1 is held in the torch member 26, in a state of slightly protruding from the distal end portion of the tip 23. The welding electrode EL1 is formed of, for example, a metal material such as steel, stainless steel or aluminum.

In the welding process, a drive voltage is applied from the power supply unit 28 of the first welding machine 20A to the welding electrode EL1 and the second electrode EL2. The welding electrode EL1 is continuously supplied with power by contact with the tip 36, and an arc is generated between the welded object 10 and the welding electrode EL1. The first weld zone WA welded by this arc.

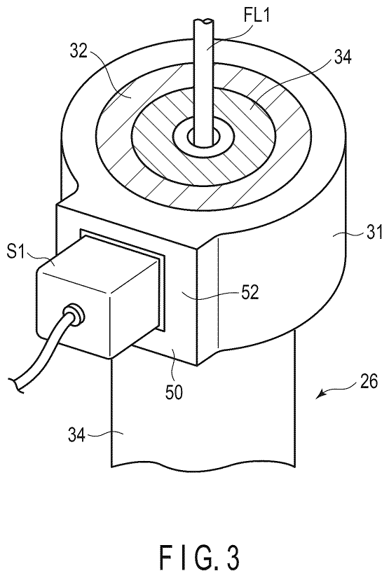

FIG. 3 is a perspective view showing the joint block portion of the torch member and the first AE sensor.

According to the present embodiment, as shown in FIG. 3, the joint block 31 is formed in an annular shape and has a flat installation surface 50 on a part of the outer circumference. In one example, a convex portion 52 is integrally formed on the outer circumference of the joint block 31, and the end face of the convex portion 52 serves as the flat installation surface 50. Incidentally, a part of the outer circumference of the joint block 31 may be processed as the flat installation surface 50 without providing the convex portion.

The first AE sensor S1 is installed on the installation surface 50 of the joint block 31. More precisely, the first AE sensor S1 has a flat receiving surface and is attached to the joint block 31 in a state in which this receiving surface is in close contact with the installation surface 50. The first AE sensor S1 is connected to a first processing circuit to be described below via wiring. Incidentally, the shape of the first AE sensor S1 is not limited to the prismatic shape shown in the drawing, but any shape of the sensor can be applied.

As shown in FIG. 2, the second welding machine 20B has the same configuration as the above-described first welding machine 20A. The same portions are denoted by the same reference numerals. The torch member 26 of the second welding machine 20B, like the torch member 26 of the first welding machine 20A, consists of a torch body clamp 32, a torch body 34, a tip body 35, a tip 36, a nozzle 37, and a joint block 31, which are formed of metal materials capable of propagating the AE waves, such as steel, copper, and brass. The torch body clamp 32, the torch body 34, the tip body 35, the tip 36, the nozzle 37, and the joint block 31 are tightly attached to each other and constitute a continuous structure. The joint block 31 has a flat installation surface 50 on a part of its outer circumference. The second AE sensor S2 is attached to the joint block 31 in a state in which its receiving surface is in close contact with the installation surface 50.

The second welding machine 20B includes a welding electrode (metal wire) EL1 inserted into the torch member 26 and a second electrode EL2 that pairs with the welding electrode EL1 and energizes the welded object 10.

As shown in FIG. 2, the controller 60 comprises an MPU (microprocessor) 62 that functions as a main control unit, and a memory 64 that stores various data such as determination results and reference data. In the present embodiment, the controller 60 includes a first processing circuit 40A and a second processing circuit 40B, which form parts of the monitoring device 30. The MPU 62 is connected to the first welding machine 20A, the second welding machine 20B, the first processing circuit 40A, and the second processing circuit 40B and controls their operations. In addition, the MPU 62 stores the determination results of the first processing circuit 40A and the second processing circuit 40B in the memory 64.

The first welding machine 20A configured as described above breaks the insulation and generates an arc in the first weld zone WA of the welded object 10 by applying a voltage between the welded object 10 and the welding electrode EL1. The second welding machine 20B breaks the insulation and generates an arc in the second weld zone WB by applying a voltage between the welded object 10 and the welding electrode EL1. In the present embodiment, the time when the arc is generated in the first weld zone WA is set to be the same as the time when the arc is generated in the second weld zone WB, but the present embodiment is also advantageous when the time when the arc is generated in the first weld zone WA is not the same as the time when the arc is generated in the second weld zone WB. The first weld zone WA and the second weld zone WB are spatially separated from each other. The interval between the first weld zone WA and the second weld zone WB is approximately 30 cm in the present embodiment, but may be greater than the distance.

The monitoring device 30 in the present embodiment is a system of detecting the welding conditions of the first weld zone WA and the second weld zone WB, which are the welding targets, by detecting unsteady elastic waves (AE waves) generated at the distal end of the welding electrode in the welding of the welded object 10.

As shown in FIG. 2, the monitoring device 30 includes the first AE sensor S1 attached to the torch member 26 of the first welding machine 20A, the second AE sensor S2 attached to the torch member 26 of the second welding machine 20B, the first processing circuit 40A that processes the detection signal of the first AE sensor S1, and the second processing circuit 40B that processes the detection signal of the second AE sensor S2. In the present embodiment, the first processing circuit 40A and the second processing circuit 40B are configured within the controller 60. The joint block 31 in which the AE sensors S1 and S2 are installed may be an element that constitutes part of the monitoring device 30.

The first AE sensor S1 receives the elastic waves generated from the first weld zone WA via the torch member 26 and converts the elastic waves into electrical signals. Similarly, the second AE sensor S2 receives the elastic waves generated from the second weld zone WB via the torch member 26 and converts the elastic waves into electrical signals.

Each of the first AE sensor S1 and the second AE sensor S2 includes a piezoelectric element as a conversion element. The piezoelectric element is formed of PZT (lead zirconate titanate), LiNbO3 (lithium niobate single crystal), GaPO4 (gallium phosphate), AlN (aluminum nitride), La3Ga5SiO14 (langasite), Ga2Al2SiO7 and the like. In particular, piezoelectric elements formed of LiNbO3, AlN, Ga2Al2, SiO7, and the like are suitable for those used in harsh environments of high temperature and high radiation.

Electro-magnetic acoustic transducers (EMAT), which convert the acoustic energy into electrical signals (electrical vibrations) by the interaction of electro-magnetic induction effects and magnetic fields, may be used as the conversion elements of the first AE sensor S1 and the second AE sensor S2.

Sensors having high sensitivity frequency characteristics in the waveform spectrum of the elastic waves generated by the welding phenomenon are desirably selected as the first AE sensor S1 and the second AE sensor S2. In the present embodiment, sensors having high sensitivity frequency characteristics in the band from 100 kHz to 200 kHz are selected, but are not limited to this frequency band only.

The first processing circuit 40A of the monitoring device 30 includes a first detection unit 41a that detects the signal of the first AE sensor S1, a first recording unit 42a that records the detected signal, and a first determination unit 44a that determines the welding condition of the first weld zone WA based on the detected signal. The second processing circuit 40B includes a second detection unit 41b that detects the signal of the second AE sensor S2, a second recording unit 42b that records the detected signal, and a second determination unit 44b that determines the welding condition of the second weld zone WB based on the detected signal.

The first detection section 41a is electrically connected to the first AE sensor S1, and amplifies and filters the electrical signal transmitted from the first AE sensor S1. Similarly, the second detection unit 41b is electrically connected to the second AE sensor S2, and amplifies and filters the electrical signal transmitted from the second AE sensor S2.

More specifically, the first detection section 41a and the second detection section 41b include circuits that electrically amplify weak electrical signals transmitted from piezoelectric elements of the first AE sensor S1 and the second AE sensor S2 and perform frequency filtering as necessary. The circuits can be composed of analog or digital circuits. In addition, the circuits may include programmable logic devices (hereinafter referred to as PLD). Incidentally, for example, programmable gate arrays, so-called field-programmable gate arrays (FPGA), can be used for the PLD. The degree of electrical amplification of the weak electrical signals is desirably 10 times or more.

The frequency of the elastic waves generated by the weld zones is generally in a range from several kHz to several MHz. Therefore, the amplification bandwidth in the first detection unit 41a and the second detection unit 41b is desirably a broadband in a range from approximately several kHz to several tens of MHz. The frequency filtering process of amplifying this bandwidth can be realized by using high-pass filters, low-pass filters, and band-pass filters.

The first recording unit 42a records the electrical signals of the first AE sensor S1 transmitted from the first detection first detection unit 41a. The second recording unit 42b records the electrical signals of the second AE sensor S2 transmitted from the second detection unit 41b.

In the present embodiment, each of the first recording unit 42a and the second recording unit 42b includes a processor (not shown) capable of executing various operations and a memory (not shown) capable of storing various constants. Each of the first recording unit 42a and the second recording unit 42b can be realized by a general computer. Incidentally, the first recording unit 42a and the second recording unit 42b may be configured using a plurality of electrical circuits (processing circuits) and a plurality of computers for each of various functions.

The first determination unit 44a is electrically connected to the first recording unit 42a and determines the welding condition of the first weld zone WA based on the record of the detected signal of the first AE sensor S1. More specifically, the first determination unit 44a determines whether the welding condition of the first weld zone WA is good or bad by comparing the detected signal of the first AE sensor S1 with the reference data (recorded signal of a good weld) prepared in advance.

The second determination unit 44b is electrically connected to the second recording unit 42a and determines the welding condition of the second weld zone WB based on the record of the detected signal of the second AE sensor S2. More specifically, the second determination unit 44b determines whether the welding condition of the first weld zone WA is good or bad by comparing the detected signal of the second AE sensor S1 with the reference data (recorded signal of a good weld).

Next, the operations of the welding apparatus 100 and the monitoring device 30 configured as described above will be described.

In the welding process, the first welding machine 20A applies drive voltages from the power supply unit 28 to the welding electrode EL1 and the second electrode EL2. The welding electrode EL1 is continuously supplied power by contact with the tip 36, and breaks the insulation and generates an arc in the first weld zone WA by applying a voltage between the welded object 10 and the welding electrode EL1. The first weld zone WA is welded by the generated arc. With the welding electrode EL1 supplied the power, the robot arm 24 is driven to move the distal end portion of the torch member 26 along the first weld zone WA and continuously weld the first weld zone WA.

Similarly, the second welding machine 20B applies drive voltages from the power supply unit 28 to the welding electrode EL1 and the second electrode EL2. The welding electrode EL1 is continuously supplied power by contact with the tip 36, and breaks the insulation and generates an arc in the second weld zone WB by applying a voltage between the welded object 10 and the welding electrode EL1. The second weld zone WB is welded by the generated arc. With the welding electrode EL1 supplied the power, the robot arm 24 is driven to move the distal end portion of the torch member 26 along the second weld zone WB and continuously weld the second weld zone WB.

In the present embodiment, the welding timing of the first weld zone WA is substantially the same as that of the second weld zone WB. The present embodiment is not limited to this, and is also advantageous when the timing of both welds is not the same. The first weld zone WA and the second weld zone WB are spatially separated from each other. The interval between the first weld zone WA and the second weld zone WB is approximately 30 cm in the present embodiment, but may be greater than the distance.

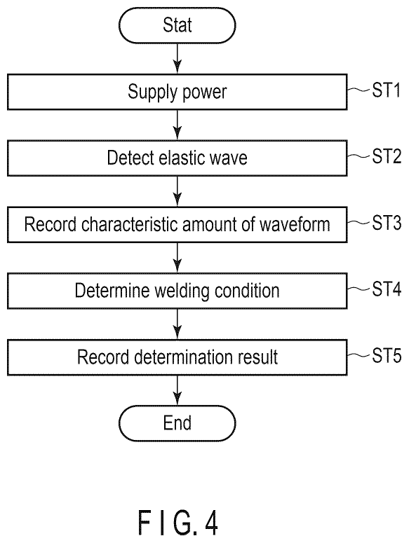

FIG. 4 is a flowchart showing an example of the operation of the monitoring device 30.

As shown in the drawing, power is supplied from the power supply unit 28 to the welding electrode EL1 (ST1), and arcs are generated in the first weld zone WA and the second weld zone WB, in the welding process. When an arc is generated in the welding area, a droplet migration phenomenon occurs from the welding electrode ELE1 in the weld zone. In accordance with the droplet migration, unsteady elastic waves (AE waves) are generated at the distal end of the welding electrode EL1.

In the first weld zone WA, the unsteady elastic waves generated at the welding electrode EL1 reach the first AE sensor S1 installed on the installation surface 50 of the joint block 31 via the torch member 26 of the welding machine 20A, i.e., by propagating the tip 36, the tip body 35, the torch body 34, and the joint block 31. Similarly, in the second weld zone, the unsteady elastic waves generated at the welding electrode EL1 reach the second AE sensor S2 installed on the installation surface 50 of the joint block 31 via the torch member 26 of the second welding machine 20B, i.e., by propagating the tip 36, the tip body 35, the torch body 34, and the joint block 31.

A transducer such as a piezoelectric element provided in each of the first AE sensor S1 and the second AE sensor S2 receives the arriving elastic waves and convert their acoustic energy into electrical signals, for example, voltages.

The elastic waves arriving at the first AE sensor S1 reflect the droplet migration phenomenon in the first weld zone WA, and do not include elastic waves caused by cracks occurring in the welded object 10 or elastic waves caused by the droplet migration phenomenon in the second weld zone WB. The elastic waves caused by cracks in the welded object 10 and the elastic waves caused by the droplet migration phenomenon in the second weld zone WB propagate through the welded object 10, but the elastic waves propagating through the welded object 10 do not propagate through the welding electrode EL1 of the first weld zone WA (first welding machine 20A). This is because a gap between the welded object 10 and the welding electrode EL1 is filled with gas.

Similarly, the elastic waves arriving at the second AE sensor S2 reflect the droplet migration phenomenon in the second weld zone WB, and do not include elastic waves caused by cracks occurring in the welded object 10 or elastic waves caused by the droplet migration phenomenon in the first weld zone WA.

As a result, the first AE sensor S1 generates electrical signals representing elastic waves that reflect only the welding condition of the first weld zone WA. The second AE sensor S2 generates electrical signals representing the elastic waves reflecting only the welding condition of the second weld zone WB. The electrical signals generated by the first AE sensor S1 are transmitted to the first detection unit 41a of the first processing circuit 40A. The electrical signals generated by the second AE sensor S2 are transmitted to the second detection unit 41b of the second processing circuit 40B.

The first detection unit 41a detects the elastic waves by amplifying and filtering the electrical signals transmitted from the first AE sensor S1 (ST2). Similarly, the second detection unit 41b detects the elastic waves by amplifying and filtering the electrical signals transmitted from the second AE sensor S2 (ST2).

The first recording unit 42a records the characteristic amount of the waveform of the electrical signals of the first AE sensor S1, which are transmitted from the first detection unit 41a (ST3). The second recording unit 42b records the characteristic amount of the waveform of the electrical signals of the second AE sensor S2, which are transmitted from the second detection unit 41b (ST3).

The first determination unit 44a determines whether the welding condition of the first weld zone WA is good or bad by comparing the characteristic amount of the waveform recorded in the first recording unit 42a with the reference data (recorded signal of a good weld) prepared in advance (ST4). The determination result is recorded in the memory 64 of the controller 60 (ST5).

Similarly, the second determination unit 44b determines whether the welding condition of the second weld zone WB is good or bad by comparing the characteristic amount of the waveform recorded in the second recording unit 42b with the reference data (recorded signals of a good weld) prepared in advance (ST4). The determination result is recorded in the memory 64 of the controller 60 (ST5).

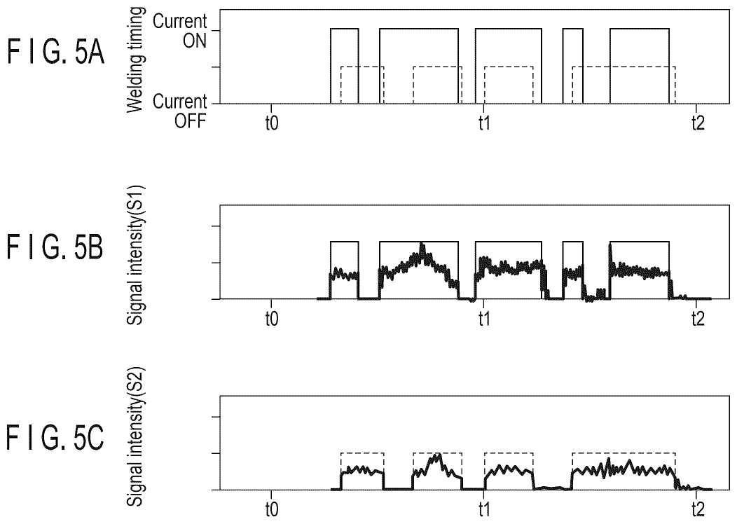

FIG. 5A is a diagram showing the weld timing of the first weld zone WA (solid line) and the weld timing of the second weld zone WB (dashed line). FIG. 5B is a diagram showing an example of the waveform of the elastic wave transmitted from the first AE sensor S1, which is detected by the first detection unit 41a and recorded by the first recording unit 42a, and also shows the signal intensity with respect to measurement time t. FIG. 5C is a diagram showing an example of the waveform of the elastic wave transmitted from the second AE sensor S2, which is detected by the second detection unit 41b and recorded by the second recording unit 42b, and also shows the signal intensity with respect to measurement time t.

As shown in FIGS. 5A to 5C, the waveform of the elastic wave detected by the first AE sensor S1 is not affected by the elastic wave generated by the welding of the second weld zone WB, and the signal intensity is confirmed in accordance with the welding timing of the first weld zone WA. As a result, it can be understood that the first AE sensor S1 generates the electrical signal representing the elastic wave that reflects only the welding condition of the first weld zone WA.

Similarly, the waveform of the elastic wave detected by the second AE sensor S2 is not affected by the elastic wave generated by the welding of the first weld zone WA, and the signal intensity is confirmed in accordance with the welding timing of the second weld zone WB. As a result, it can be understood that the second AE sensor S2 generates the electrical signal representing the elastic wave that reflects only the welding condition of the second weld zone WB.

According to the welding apparatus 100 and the monitoring device 30 of the present embodiment configured as described above, even when the first weld zone WA and the second weld zone WB of the common welded object 10 are welded simultaneously by two welding machines 20A and 20B, the first AE sensor S1 can generate the electrical signal representing the elastic wave that reflects only the welding condition of the first weld zone WA, and the second AE sensor S2 can generate the electrical signal representing the elastic wave that reflects only the welding condition of the second weld zone WB. Accordingly, even when the first weld zone WA and the second weld zone WB of the welded object 10 are welded simultaneously, the welding condition of the first weld zone WA and the welding condition of the second weld zone WB can be distinguished and accurately monitored (determined).

In addition, according to the present embodiment, the torch member 26 has the flat installation surface 50, and each of the AE sensor S1 and S2 is installed on the torch member 26 in a state in which its receiving surface is in close contact with the installation surface 50. Therefore, each of the AE sensor S1 and S2 can easily detect the elastic waves propagating through the torch member 26 with high accuracy.

Furthermore, the first AE sensor S1 and the second AE sensor S2 are provided at the proximal ends (joint blocks 31) of the torch members 26, in the present embodiment, i.e., at the positions where the elastic waves of sufficient signal strength can be detected while maintaining a distance from the first weld zone WA and the second weld zone WB in a range of being unaffected by spatter or process heat generated in the first weld zone WA and the second weld zone WB. Therefore, the first AE sensor S1 and the second AE sensor S2 can maintain high detection performance and reliability even when the first AE sensor S1 and the second AE sensor S2 are installed in the torch members 26 formed of the metallic material.

As a result, according to the present embodiment, a welding apparatus and a weld monitoring device capable of accurately monitoring the welding condition of the individual weld zone, even when simultaneously welding a plurality of parts of the same weld object can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above-described embodiment, the number of welding machines is not limited to two, but may be three or more. The same advantages as those of the above-described embodiment can be obtained by providing the AE sensor in the torch member of each welding machine. Various welding machines including gas shielded arc welding machines for MAG welding and MIG welding can be applied as welding machines.

The configuration of the torch member is not limited to the configuration of the embodiment described above, but can be changed as necessary or according to the model of the welding machine. The installation surface on which the AE sensor is installed is not limited to the proximal end (joint block) of the torch member, but may be provided on the other member of the torch body, for example, an outer circumference of the torch body. In other words, the AE sensor may be installed at the position, in the torch member, where elastic waves with sufficient signal strength can be detected while maintaining a distance from the weld zone in a range of being unaffected by spatter or process heat generated in the weld zone.

What is claimed is:

1. A welding apparatus comprising:
a first welding machine comprising an arm, a first torch member including a proximal end portion connected to the arm, a distal end portion opposed to a weld object, and a flat installation surface and formed of a metallic material, a welding electrode inserted into the first torch member and protruding from the distal end portion, and a power supply unit which applies a voltage between the welding electrode and the weld object, to weld a first weld zone of the weld object;
a second welding machine comprising an arm, a second torch member including a proximal end portion connected to the arm, a distal end portion opposed to the weld object, and a flat installation surface and formed of a metallic material, a welding electrode inserted into the second torch member and protruding from the distal end portion, and a power supply unit which applies a voltage between the welding electrode and the weld object, to weld a second weld zone different from the first weld zone of the weld object; and
a monitoring device comprising a first sensor installed on the installation surface of the first torch member and configured to detect an elastic wave transmitted to the first torch member, a second sensor installed on the installation surface of the second torch member and configured to detect an elastic wave transmitted to the second torch member, a first processing circuit configured to determine a welding condition of the first weld zone based on a detection signal transmitted from the first sensor, and a second processing circuit configured to determine a welding condition of the second weld zone based on a detection signal transmitted from the second sensor.

2. The welding apparatus of claim 1, wherein
each of the first torch member and the second torch member includes an annular joint block constituting the proximal end portion, a tip and a tip body constituting the distal end portion, and a torch body located between the joint block and the tip body, and
the joint block has the installation surface.

3. The welding apparatus of claim 2, wherein
the joint block includes a convex portion formed on an outer circumference, and the installation surface is provided on the convex portion.

4. The welding apparatus of claim 1, wherein
the first processing circuit includes a first detection unit that detects a detection signal of the first sensor, a first recording unit that records a characteristic amount of a waveform of the detection signal, and a first determination unit that determines whether a welding condition of the first weld zone is good or bad based on the recorded characteristic amount, and
the second processing circuit includes a second detection unit that detects a detection signal of the second sensor, a second recording unit that records a characteristic amount of a waveform of the detection signal, and a second determination unit that determines whether a welding condition of the second weld zone is good or bad based on the recorded characteristic amount.

5. A monitoring device for detecting:
a welding condition of a first weld zone of a welded object welded by a first welding machine comprising an arm, a first torch member including a proximal end portion connected to the arm, a distal end portion opposed to a weld object, and a flat installation surface and formed of a metallic material, a welding electrode inserted into the first torch member and protruding from the distal end portion, and a power supply unit which applies a voltage between the welding electrode and the weld object; and
a welding condition of a second weld zone of a welded object welded by a second welding machine comprising an arm, a second torch member including a proximal end portion connected to the arm, a distal end portion opposed to a weld object, and a flat installation surface and formed of a metallic material, a welding electrode inserted into the second torch member and protruding from the distal end portion, and a power supply unit applying a voltage between the welding electrode and the weld object,
the monitoring device comprising:
a first AE sensor provided on the first torch member to detect an elastic wave transmitted to the first torch member;
a second AE sensor provided on the second torch member to detect an elastic wave transmitted to the second torch member;
a first processing circuit configured to determine a welding condition of the first weld zone, based on a detection signal transmitted from the first AE sensor; and
a second processing circuit configured to determine a welding condition of the second weld zone, based on a detection signal transmitted from the second AE sensor.

6. The monitoring device of claim 5, wherein
the first torch member has a flat installation surface formed on the proximal end portion, and the first AE sensor is provided to be in close contact with the installation surface.

7. The monitoring device of claim 5, wherein
the second torch member has a flat installation surface formed on the proximal end portion, and the second AE sensor is provided to be in close contact with the installation surface.

8. The monitoring device of claim 5, wherein
the first processing circuit includes a first detection unit that detects a detection signal of the first AE sensor, a first recording unit that records a characteristic amount of a waveform of the detection signal, and a first determination unit that determines whether a welding condition of the first weld zone is good or bad based on the recorded characteristic amount, and
the second processing circuit includes a second detection unit that detects a detection signal of the second AE sensor, a second recording unit that records a characteristic amount of a waveform of the detection signal, and a second determination unit that determines whether a welding condition of the second weld zone is good or bad based on the recorded characteristic amount.
